(19) United States
(12) Patent Application Publication
(10) Pub. No.: US 2013/0032261 A1
(43) Pub. Date: Feb. 7, 2013

(54) Pneumatic Tire

(71) Applicant: Hiraku Kouda, Hiratsuka-shi (JP)

(72) Inventor: Hiraku Kouda, Hiratsuka-shi (JP)

(21) Appl. No.: 13/641,416

(22) PCT Filed: Apr. 28, 2011
(86) PCT No.: PCT/JP2011/060397

§ 371 Date: Oct. 15, 2012

(30) Foreign Application Priority Data
May 10, 2010 (JP) 2010-108213

(51) Int. Cl. B60C 11/12

(52) U.S. Cl. 152/209.18

(57) ABSTRACT

An object of the present technology is to provide a pneumatic tire whereby both performance on ice and dry performance can be achieved. A plurality of blocks is provided in a tread portion, a sipe being provided in at least one of the blocks. The sipe is, as a whole, a primary waveform sipe having, in a tread road contact surface, at least one peak portion and one trough portion. The primary waveform sipe is also an aggregation of secondary waveform sipes having a shorter wavelength.

### TECHNICAL FIELD

The present technology relates to a pneumatic tire, and particularly relates to a pneumatic tire having sipes formed in a tread surface thereof.

### BACKGROUND

It is preferable to increase the edge length of land portion of a tread pattern or increase rigidity of said land portion in order to enhance performance on ice and dry performance. However, when the edge length of the land portion of a tread pattern is increased, the rigidity of the land portion decreases. Therefore, it is difficult to achieve both an increase in the edge length of land portion and an increase in the rigidity of land portion.

To date, many techniques have been developed for forming three-dimensional sipes in a tread surface in order to achieve both performance on ice and dry performance. However, when forming three-dimensional sipes in a tread surface, there are problems such as cost, manufacturing techniques, and the like. From the perspective of such problems, technologies for enhancing various performances of tires by forming multiple sipes in a tread surface are exemplified by the following.

Japanese Unexamined Patent Application Publication No. H04-173407A describes a pneumatic tire in which multiple blocks are provided in a tread portion. At least one wave-like kerf extending in a tire width direction is provided in said blocks, and a line joining center points of an amplitude of said wave-like kerf is formed so as to vary in a tire circumferential direction. With this pneumatic tire, lateral resistance increases and cornering performance on snowy and icy roads is enhanced due to an increase in a ratio of the tire circumferential direction kerf component. Additionally, braking and driving performance on snowy and icy roads when traveling straight can be enhanced due to an increase in the total length and density of the kerf.

Japanese Unexamined Patent Application Publication No. 2006-096283A describes a pneumatic tire that includes multiple blocks formed by a plurality of mutually intersecting main grooves in a tread. At least one sipe having a wave shape in a tire width direction is formed in the blocks. The sipe curves in a depth direction and a tire circumferential direction; and the curve is opposite on an inner side and an outer side when the tire is mounted on a vehicle, having a tire equator line as a boundary between the inner side and the outer side. With this pneumatic tire, it is proposed that braking and driving performance and cornering performance on ice and snow can be enhanced.

The technologies described in Japanese Unexamined Patent Application Publication Nos. H04-173407A and 2006-096283A both seek to enhance various performances of a tire by forming sipes in a tread surface thereof. However, the overall form of the sipes used in these technologies have a peak portion or trough portion at only one location in the tread road contact surface or, the overall form is a single straight line in a tire width direction. Therefore, because the form of the sipe is relatively simple, there is a possibility that both performance on ice and dry performance cannot be sufficiently achieved.

### SUMMARY

The present technology provides a pneumatic tire whereby both performance on ice and dry performance can be achieved. A pneumatic tire of the present technology includes a plurality of blocks in a tread portion, a sipe being provided in at least one of the blocks. The sipe is, as a whole, a primary waveform sipe having, in a tread road contact surface, at least one peak portion and one trough portion. The primary waveform sipe is also an aggregation of secondary waveform sipes having a shorter wavelength.

With this pneumatic tire, the sipe is formed in the block. The sipe is, as a whole, a primary waveform sipe having, in a tread road contact surface, at least one peak portion and one trough portion. Moreover, the primary waveform sipe is an aggregation of secondary waveform sipes having a shorter wavelength. In a coordinate system wherein a tire width direction and a tire circumferential direction are a Y-axis and an X-axis, respectively, the overall form of the sipe has no fewer than two limit values, and two types of waveforms having different sizes are present in the sipe. This means that the form of the sipe is complex.

Because the form of the sipe is complex, the direction of collapsing of land portion, caused by the presence of the sipe, is dispersed. As a result, sufficient rigidity of the land portion in the vicinity of the sipe can be obtained. Additionally, because the edge length of the land portion can be increased due to the form of the sipe being made complex, biting effects by the pattern edges can be sufficiently ensured. Thus, with this pneumatic tire, both performance on ice and dry performance can be achieved.

With this pneumatic tire, when a wavelength and an amplitude of the primary waveform sipe are λ1 and y1, respectively, and a wavelength and an amplitude of the secondary waveform sipe are λ2 and y2, respectively, λ1≧2×(λ2) or y1>y2 is preferably satisfied. By satisfying λ1≧2×(λ2), at least two wavelengths of the secondary waveform sipe can be included in one wavelength of the primary waveform sipe in the tire width direction, and the length and the density of the sipe can be increased. Additionally, by satisfying y1>y2, the amplitude of the primary waveform sipe can be sufficiently ensured compared to the amplitude of the secondary waveform sipe and, therefore, the length and the density of the sipe can be increased. By making the wavelengths and the amplitudes of the primary waveform and the secondary waveform appropriate, the rigidity of the land portion can be increased due to the dispersion of the direction of collapsing of the land portion in the vicinity of the sipe, and biting effects by the pattern edges can be sufficiently ensured due to the increase in the edge length of the land portion. Therefore, both performance on ice and dry performance can be achieved.

Additionally, with this pneumatic tire, preferably, at least one of the wavelength of the primary waveform sipe and the amplitude of the primary waveform sipe, along with at least one of the wavelength of the secondary waveform sipe and the amplitude of the secondary waveform sipe are varied in the tire width direction. By appropriately varying the factors that determine the forms of these sipes in the tire width direction, the rigidity of the land portion can be increased due to the dispersion of the direction of collapsing of the land portion in the vicinity of the sipe, and biting effects by the pattern edges can be sufficiently ensured due to the increase in the edge length of the land portion, particularly locally in the tire width direction. As a result, balance between the edge length of the land portion and the block rigidity can be adjusted and, therefore, both performance on ice and dry performance can be achieved.

Additionally, with this pneumatic tire, the amplitude y1 of the primary waveform sipe is preferably not less than 1.5 mm, and the amplitude y2 of the secondary waveform sipe is preferably not less than 0.8 mm. Configuring each of the amplitude y1 of the primary waveform sipe to be not less than 1.5 mm, and the amplitude y2 of the secondary waveform sipe to be not less than 0.8 mm leads particularly to the biting effects by the pattern edges being enhanced due to the sufficient ensuring of the edge length of the land portion. Therefore, performance on ice and dry performance can be further enhanced.

Additionally, with this pneumatic tire, the wavelength λ1 of the primary waveform sipe is preferably not loss than ⅓ of a width of the block in which the primary waveform sipe is formed, and the wavelength λ2 of the secondary waveform sipe is preferably not less than 2.0 mm. Configuring each of the wavelength λ1 of the primary waveform sipe to be not less than ⅓ of a width of the block, and the wavelength λ2 of the secondary waveform sipe to be not less than 2.0 mm leads particularly to spacing between limit values being sufficiently ensured. As a result, the sipes can be suppressed from becoming excessively dense in the tire width direction, and excellent releasability from a die can be obtained. As a result, in cases where the wavelengths λ1 and λ2 are preferably set as described above, a pneumatic tire in which sipes are formed with high precision can be obtained.

Additionally, with this pneumatic tire, at least a portion of the sipe is preferably three-dimensional. By configuring at least a portion of the primary waveform sipe to be three-dimensional, particularly, collapsing of the land portion in the vicinity of the sipe can be sufficiently suppressed and, as a result, the rigidity of the land portion can be further enhanced. Therefore, performance on ice and dry performance can be further enhanced.

With the pneumatic tire according to the present technology, both performance on ice and dry performance can be achieved.

### BRIEF DESCRIPTION OF THE DRAWINGS

FIG. 1 is a plan view illustrating an example of the main constituents of a tread portion of a pneumatic tire according to a first embodiment.

FIG. 2 is an explanatory drawing illustrating wavelengths and amplitudes for a primary waveform and a secondary waveform of the sipe depicted in FIG. 1.

FIG. 3 is a plan view illustrating an example of the main constituents of a tread portion of a pneumatic tire according to a second embodiment.

FIG. 4 is an explanatory drawing illustrating wavelengths and amplitudes for a primary waveform and a secondary waveform of the sipe depicted in FIG. 3.

FIG. 5 is a table showing results of performance testing of pneumatic tires according to examples of the present technology.

### DETAILED DESCRIPTION

An embodiment of the present technology is described below in detail based on the drawings. However, the present technology is not limited to this embodiment. The constituents of the embodiment include constituents that can be easily replaced by those skilled in the art and constituents substantially same as the constituents of the embodiment. Furthermore, the multiple modified examples described in the embodiment can be combined as desired within the scope apparent to a person skilled in the art. Note that in the following description, “tire circumferential direction” refers to a circumferential direction with the tire rotational axis as a center axis. Additionally, “tire width direction” refers to a direction parallel to the tire rotational axis.

### First Embodiment

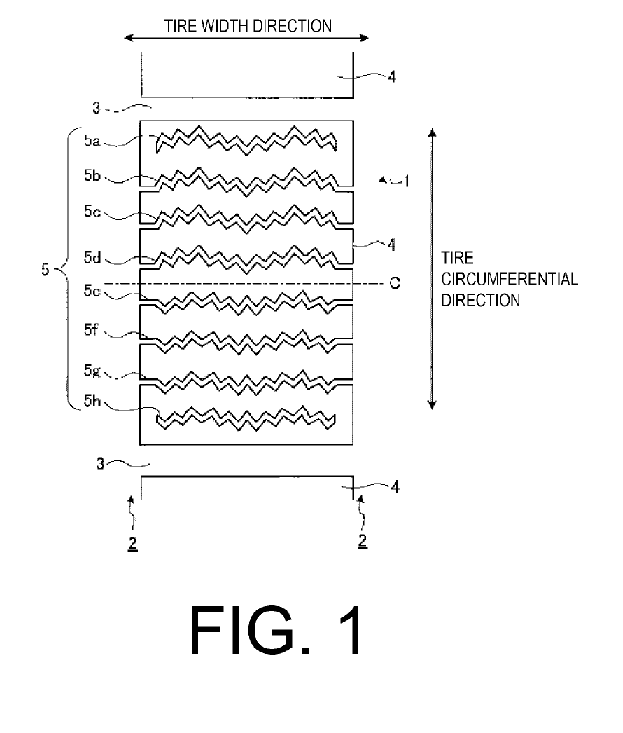

FIG. 1 is a plan view illustrating an example of the main constituents of a tread portion of a pneumatic tire according to the first embodiment. A plurality of circumferential grooves 2 extending substantially in the tire circumferential direction, and a plurality of lateral grooves 3 communicating with two of the circumferential grooves 2 that are adjacent thereto are disposed in a tread portion 1 in the pneumatic tire shown in this drawing. Thereby, multiple block land portions 4 are partitioned in the tread portion 1.

A sipe group 5 extending substantially in the tire width direction is formed in a block land portion 4 that was formed as described above. The sipe group 5 is constituted from eight sipes disposed sequentially in the tire circumferential direction: 5a, 5b, 5c, 5d, 5e, 5f, 5g, and 5b. Of these sipes 5a to 5h, the sipes 5a and 5h, which are closest to the lateral grooves 3, are formed within the block land portion 4, and are not in communication with the circumferential grooves 2 that are located on both outer sides in the tire width direction of the block land portion 4. In contrast, the remaining sipes 5b to 5g, which are comparatively distanced from the lateral grooves 3, are in communication with each of the circumferential grooves 2 that are located on both outer sides in the tire width direction of the block land portion 4. By forming the sipes 5a and 5h that are closest to the lateral grooves 3 within the block land portion 4 as described above, rigidity at portions of the block land portion 4 close to the lateral grooves 3 can be particularly sufficiently ensured. On the other hand, by configuring the other sipes 5b to 5g to be in communication with the circumferential grooves 2, the edge length of the block land portion 4 in the vicinity of the sipes 5b to 5g can be particularly sufficiently ensured.

Additionally, as illustrated in FIG. 1, respective forms of the sipes 5a to 5d and the sipes 5c to 5h are substantially symmetrical to each other around a tire circumferential direction center line C of the block land portion 4. Specifically, the sipe 5a and the sipe 5h, the sipe 5b and the sipe 5g, the sipe 5c and the sipe 5f, and the sipe 5d and the sipe 5c are respectively substantially symmetrical to each other around the tire circumferential direction center line C. By configuring the sipes so as to have a substantially symmetrical form, various performances of the tire can be substantially equally exerted, not only when the rotational direction of the tire is the forward direction, but also when the rotational direction is the backward direction. “Forward direction” refers to a tire rotational direction when a vehicle on which the tire is mounted is moving forward, and “backward direction” refers to a tire rotational direction when the vehicle is moving backward.

Under such a configuration, an exemplary sipe 5b of the sipe group 5 illustrated in FIG. 1 is formed as described below. Note that hereinafter, in a coordinate system where the tire width direction is the Y-axis and the tire circumferential direction is the X-axis, a form of the sipe 5b that appears on the road contact surface of the tire is the waveform of the sipe. Additionally, a wavelength and an amplitude of said waveform are the wavelength and the amplitude of the sipe 5b. Furthermore, the waveform of the sipe 5b that appears on the road contact surface of the tire, when viewed as a whole, is referred to as a “primary waveform” of the sipe 5b, and a waveform of the sipe 5b, when viewed locally, is referred to as a “secondary waveform” of the sipe 5b. Moreover, a peak portion and a trough portion of the sipe 5b in the coordinate system described above are referred to as “limit values” (maximal value and minimal value) of the sipe 5b.

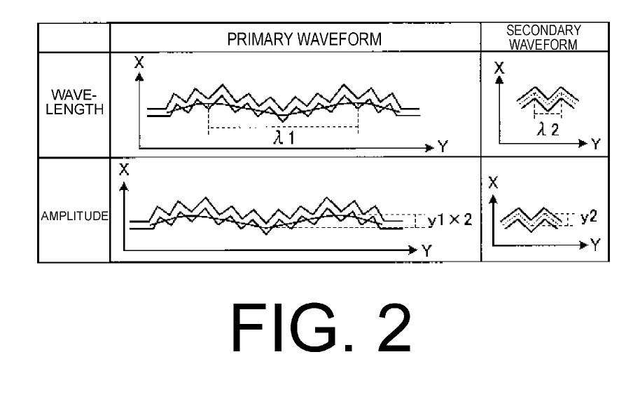

FIG. 2 is an explanatory drawing illustrating wavelengths and amplitudes for a primary waveform and a secondary waveform of the sipe depicted in FIG. 1. The sipe 5b is a primary waveform sipe having at least two (three in FIG. 2) limit values. Specifically, the sipe 5b is a primary waveform extending in the tire width direction, having two maximal values and one minimal value. Thus, the form of the sipe depicted in FIG. 2 can be made suitably complex by the primary waveform sipe having at least two limit values. Therefore, regardless of whether the tire rotational direction is forward or backward, high rigidity can be realized to the extent that the block land portion 4 does not deform. Note that in this embodiment, “having at least two limit values” means that the primary waveform sipe also exists outward, on both sides in the tire width direction, of the at least two limit values. For example, in the example illustrated in FIG. 2, this means that, with respect to the two maximal values positioned on the outer side in the tire width direction of the three limit values, the primary waveform sipe also exists outward, on both sides in the tire width direction, of the two maximal values.

Additionally, the sipe 5b is also an aggregation of secondary waveform sipes having a wavelength that is shorter than that of the primary waveform sipe described above. As illustrated in FIG. 2, the secondary waveform sipe is defined as a substantially “M” shaped unit, and the primary waveform sipe is formed by a plurality of these units being linked in a continuous manner. Thus, the form of the sipe illustrated in FIG. 2 can be made suitably complex by combining two types of waveforms of different sizes.

Presuming that the form of the sipe is made complex as described above, the sipes 5b to 5d are further configured as described below. Specifically, with the sipe 5b, when a wavelength, and an amplitude of the primary waveform sipe are λ1 and λ1, respectively, and a wavelength and an amplitude of the secondary waveform sipe are λ2 and y2, respectively, λ1≧2×(λ2) or y1>y2 is satisfied.

Here, the “wavelength λ1 of the primary waveform sipe” refers to a horizontal distance between adjacent peaks or troughs in the waveform of the sipe. In the example illustrated in FIG. 2, the “wavelength λ1 of the primary waveform sipe” refers to the horizontal distance between the two maximal values. Here, the “amplitude y1 of the primary waveform sipe” refers to a dimension ½ of a vertical distance between an adjacent peak and trough in the waveform of the sipe. In the example illustrated in FIG. 2, the “amplitude y1 of the primary waveform sipe” refers to the dimension ½ of the vertical distance between a tire circumferential direction center point of the maximal value and a tire circumferential direction center point of the minimal value. Note that the primly waveform illustrated in FIG. 2 is the imaginary curved line (solid line) joining the tire circumferential direction center points of the trough portions.

Likewise, the “wavelength λ2 of the secondary waveform sipe” refers to a horizontal distance between adjacent peaks or troughs in the waveform of the sipe, and in the example illustrated in FIG. 2, refers to the horizontal distance between the two maximal values that exist in the secondary waveform. Additionally, the “amplitude y2 of the secondary waveform sipe” refers to a dimension ½ of a vertical distance between an adjacent peak and trough in the waveform of the sipe, and in the example illustrated in FIG. 2, refers to the dimension ½ of the vertical distance between a tire circumferential direction center point of the maximal value and a tire circumferential direction center point of the minimal value that exist in the secondary waveform. Note that the secondary waveform illustrated in FIG. 2 is the imaginary line (dashed line) joining the tire circumferential direction center points of the peak portions and the trough portions.

By configuring the relationship between the wavelength λ1 of the primary waveform sipe and the wavelength λ2 of the secondary waveform sipe to be such that λ1≧2×(λ2), at least two wavelengths of the secondary waveform sipe can be included in one wavelength of the primary waveform sipe in the tire width direction. As a result, the length of the sipe can be increased and the density of the sipes in the block land portion 4 can be increased. Note that in cases where the wavelength λ1 of the primary waveform sipe and/or the wavelength λ2 of the secondary waveform sipe varies in the tire width direction, a relationship of a minimal value λ1ₘᵢₙ of the wavelength λ1 of the primary waveform sipe and a maximal value λ2ₘₐₓ of the wavelength λ2 of the secondary waveform sipe is configured so that λ1ₘᵢₙ≧2×(λ2ₘₐₓ) is satisfied.

Additionally, by configuring the relationship between the amplitude y1 of the primary waveform sipe and the amplitude y2 of the secondary waveform sipe so that y1>y2, the amplitude y1 of the primary waveform sipe can be sufficiently ensured compared with the amplitude y2 of the secondary waveform sipe. As a result, the length of the sipe can be increased and the density of the sipes in the block land portion 4 can be increased. Note that in cases where the amplitude y1 of the primary waveform sipe and/or the amplitude y2 of the secondary waveform sipe varies in the tire width direction, a relationship of a minimal value of the amplitude y1 of the primary waveform sipe and a maximal value y2ₘₐₓ of the amplitude y2 of the secondary waveform sipe is configured so that y1ₘᵢₙ>y2ₘₐₓ is satisfied.

Thus, by making the form of the sipe 5b complex and, furthermore, appropriately configuring the relationship between the wavelength λ1 of the primary waveform and the wavelength λ2 of the secondary waveform along with the relationship between the amplitude y1 of the primary waveform sipe and the amplitude y2 of the secondary waveform sipe, the length and the density of the sipes are increased and, as a result, the direction of collapsing of the land portion in the vicinity of the sipes is dispersed. Therefore, the rigidity of said land portion can he sufficiently obtained. Additionally, due to configuring the amplitude and the wavelength of each of the waveforms as described above, the edge length of the land portion can be increased and, thereby, the biting effects by the pattern edges can be sufficiently ensured.

Note that the description given above pertains to the sipe 5b but, as illustrated in FIG. 1, the sipe 5a has the same form as the sipe 5b except that the sipe 5a does not have extending portions in the tire width direction located at both ends in the tire width direction of the sipe 5b. Additionally, the sipes 5c and 5d have the same tire width direction form as the sipe 5b. Furthermore, the sipes 5e to 5h have forms that are symmetrical to the sipes 5a to 5d around the tire circumferential direction center line C of the block land portion 4. Therefore, similar to the sipe 5b described above, land portion rigidity in the vicinity of the sipes can be sufficiently obtained with regards to the sipes 5a and 5c to 5h, and the edge length of the land portion can be increased.

Thus, with the pneumatic tire of the first embodiment, each of the sipes 5a to 5h is, as a whole, a primary waveform sipe having, in the tread road contact surface, at least one peak portion and one trough portion, and this primary waveform sipe is also an aggregation of secondary waveform sipes having a shorter wavelength. Moreover, with the pneumatic tire of the first embodiment, when a wavelength and an amplitude of the primary waveform sipe are λ1 and y1, respectively, and a wavelength and an amplitude of the secondary waveform sipe are λ2 and y2, respectively, λ1≧2×(λ2) or y1>y2 is satisfied. Therefore, the rigidity of the block land portion 4 can be increased due to the dispersion of the direction of collapsing of the block land portion 4 in the vicinity of the sipes 5a to 5b, and biting effects by the pattern edges can be sufficiently ensured due to the increase in the edge length of the block land portion 4. Therefore, both performance on ice and dry performance can be achieved.

Here, “performance on ice” refers to various performances of the tire on ice, particularly driving performance and braking performance on polished eisbahn (frozen road surfaces). “Dry performance” refers to various performances of the tire on dry road surfaces, particularly driving performance and braking performance on dry road surfaces.

In the pneumatic tire of the first embodiment, each of the sipes 5a to 5h is preferably configured so that the amplitude y1 of the primary waveform sipe is not less than 1.5 mm and the amplitude y2 of the secondary waveform sipe is not less than 0.8 mm. By configuring the amplitudes y1 and y2 in this way, the edge length of the land portion can be particularly sufficiently ensured and, as a result, the biting effects by the pattern edges can be enhanced. Therefore, performance on ice and dry performance can be further enhanced.

Additionally, in the pneumatic tire of the first embodiment, each of the sipes 5a to 5h is preferably configured so that the wavelength λ1 of the primary waveform sipe is not less than ⅓ of the width of the block in which the sipes are formed, and the wavelength λ2 of the secondary waveform sipe is not less than 2.0 mm. Here the “width of the block” refers to a maximum length in the tire width direction of the block land portion 4 formed in the tread portion 1. In the example illustrated in FIG. 1, the length in the tire width direction of the block land portion 4 is the width of the block. By configuring the wavelengths λ1 and λ2 as described above, for both the primary waveform and the secondary waveform of the sipes, spacing between the limit values can be particularly sufficiently ensured and, therefore, the sipes can be suppressed from becoming excessively dense in the tire width direction and excellent releasability from a die can be obtained. As a result, in cases where the wavelengths λ1 and λ2 are set as described above, the sipes can be formed with high precision in the tread portion 1 of the pneumatic tire.

Additionally; in the pneumatic tire of the first embodiment, each of the sipes 5a to 5h is preferably configured so that at least a portion of the sipe is three-dimensional. Here, the “sipe is three-dimensional” means that the sipe curves or the like in a depth direction of the block land portion 4. By configuring the sipes 5a to 5h so that at least a portion of the sipe is three-dimensional as described above, collapsing of the land portion in the vicinity of the sipes can be particularly sufficiently suppressed. As a result, rigidity of the land portion can be further increased and, therefore, performance on ice and dry performance can be further enhanced.

Additionally, in the pneumatic tire of the first embodiment, the secondary waveform of each of the sipes 5a to 5h is a triangular wave, but is not limited thereto. The secondary waveform of the sipes 5a to 5h can, for example, be a sine wave. Note that as illustrated in FIG. 2, in cases where the secondary waveform of the sipes 5a to 5h is a triangular wave, the sipes will have points and, therefore, the edge effects at initial use of the tire will be particularly increased.

Likewise, the primary waveform of each of the sipes 5a to 5h is a sine wave, but is not limited thereto. The primary waveform of the sipes 5a to 5h can, for example, be a triangular wave. Note that as illustrated in FIG. 2, in cases where the primary waveform of the sipes 5a to 5h is a sine wave, changes in the sipe angle at maximal values and minimal values will be gradual, and the sipe pitch can be increased. As a result, releasability from a die will be excellent and the sipes can be formed with high precision.

### Second Embodiment

Next, a description of a preferable second embodiment, separate from that of the first embodiment, will be given. The second embodiment differs from the first embodiment in that the wavelength λ1 of the primary waveform sipe and/or the amplitude y1 of the primary waveform sipe, along with the wavelength λ2 of the secondary waveform sipe and/or the amplitude y2 of the secondary waveform sipe are configured to vary in the tire width direction.

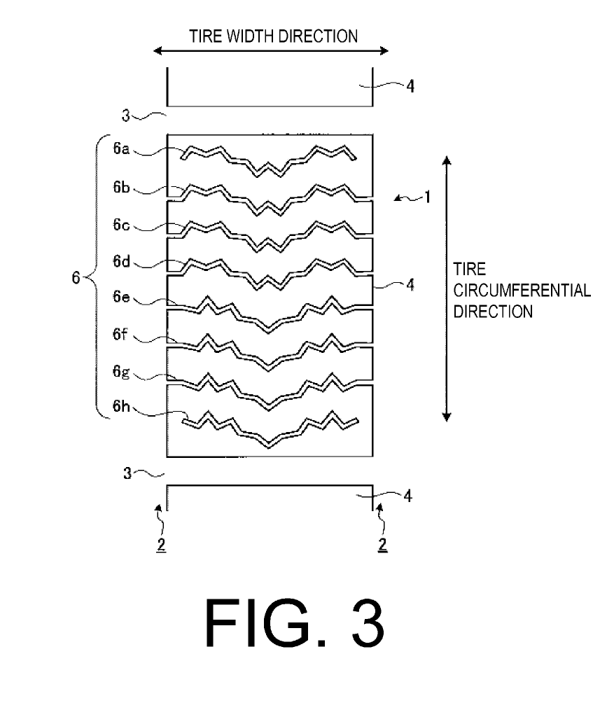

FIG. 3 is a plan view illustrating an example of the main constituents of a tread portion of a pneumatic tire according to the second embodiment. Hereinafter, the differences between the pneumatic tire illustrated in FIG. 3 and the pneumatic tire illustrated in FIG. 1 will be described. Note that in FIG. 3, those constituents that have the same reference numerals as in FIG. 1 are identical to the constituents illustrated in FIG. 1.

In the pneumatic tire illustrated in FIG. 3, a sipe group 6 extending in substantially the tire width direction is formed in a block land portion 4 that is formed in the tread portion 1. The sipe group 6 is constituted from eight sipes disposed sequentially in the tire circumferential direction: 6a, 6b, 6c, 6d, 6e, 6f, 6g, and 6h. Of the sipes 6a to 6h, the sipes 6a and 6h, which are closest to the lateral grooves 3, are formed within the block land portion 4, and are not in communication with the circumferential grooves 2 that are located on both outer sides in the tire width direction of the block land portion 4. In contrast, the remaining sipes 5b to 6g, which are comparatively distanced from the lateral grooves 3, are in communication with each of the circumferential grooves 2 that are located on both outer sides in the tire width direction of the block land portion 4. By forming the sipes 6a and 5h that are closest to the lateral grooves 3 within the block land portion 4 as described above, rigidity at portions close to the lateral grooves 3 of the block land portion 4 can be sufficiently ensured. On the other hand, by configuring the other sipes 6b to 6g to be in communication with the circumferential grooves 2, the edge length of the block land portion 4 in the vicinity of the sipes 6b to 6g can be sufficiently ensured.

Additionally; the waveforms of the sipes 6a to 6d are different from the waveforms of the sipes 6e to 6h. Specifically, as illustrated in FIG. 3, the sipes 6a to 6d have a peaked form in the vicinity of the center in the tire width direction of the block land portion 4, and the sipes 6e to 6h have a trough form in the vicinity of the center in the tire width direction of the block land portion 4. Additionally, conforming with the form in the vicinity of the center in the tire width direction, the forms of the sipes 6a to 6d and the sipes 6e to 6h are configured so that the peaked forms and trough forms thereof are substantially inverted up to the circumferential grooves 2 located on both sides in the tire width direction of the block kind portion 4. By configuring the sipes so as to have a substantially inverted form, various performances of the tire can be substantially equally exerted, not only when the rotational direction of the tire is the forward direction, but also when the rotational direction is the backward direction.

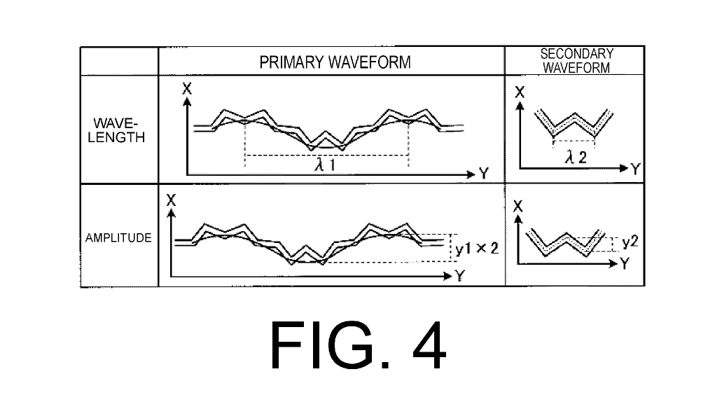

Under such a configuration, the sipe 6b of the sipe group 6 illustrated in FIG. 3 is formed as described below. FIG. 4 is an explanatory drawing illustrating wavelengths and amplitudes for a primary waveform and a secondary waveform of the sipe depicted in FIG. 3. The sipe 6h is a primary waveform sipe having at least two (three in FIG. 4) limit values. Specifically, the sipe 6b is a primary waveform extending in the tire width direction, having two maximal values and one minimal value. Thus, the form of the sipe depicted in FIG. 4 is made suitably complex by the primary waveform sipe having at least two limit values and, regardless of whether the tire rotational direction is forward or backward, high rigidity is realized to the extent that the block land portion 4 does not deform.

Additionally, the sipe 6b is also an aggregation of secondary waveform sipes having a wavelength that is shorter than that of the primary waveform sipe described above. As illustrated in FIG. 4, the secondary waveform sipe is defined as a “W” shaped unit, and the primary waveform sipe is formed by a plurality of these units being linked in a continuous manner. Thus, the form of the sipe illustrated in FIG 4 can be made suitably complex by combining two types of waveforms of different sizes.

Presuming that the form of the sipe is made complex as described above, the sipe 6b is further configured as described below. Specifically, with the sipe 6b, the wavelength λ1 of the primary waveform sipe and/or the amplitude y1. of the primary waveform sipe, along with the wavelength λ2 of the secondary waveform sipe and/or the amplitude y2 of the secondary waveform sipe are configured to vary in the tire width direction. In the example illustrated in FIG. 4, each of the wavelength λ1, the amplitude y1, the wavelength 22, and the amplitude y2 is configured so as to vary in the tire width direction.

Here, the “wavelength λ1 of the primary waveform sipe” refers to a horizontal distance between adjacent peaks or troughs in the waveform of the sipe, and in the example illustrated in FIG. 4, refers to the horizontal distance between the two maximal values. Additionally, the “amplitude y1 of the primary waveform sipe” refers to a dimension ½ of a vertical distance between an adjacent peak and trough in the waveform of the sipe, and in the example illustrated in FIG. 4, refers to the dimension ½ of the vertical distance between a tire circumferential direction center point of the maximal value and a tire circumferential direction center point of the minimal value. Note that the primary waveform illustrated in FIG. 4 is the imaginary curved line (solid line) joining the tire circumferential direction center points of the trough portions.

Likewise, the “wavelength λ2 of the secondary waveform sipe” refers to a horizontal distance between adjacent peaks or troughs in the waveform of the sipe, and in the example illustrated in FIG. 4, refers to the horizontal distance between the two minimal values. Additionally, the “amplitude y2 of the secondary waveform sipe” refers to a dimension ½ of a vertical distance between an adjacent peak and trough in the waveform of the sipe, and in the example illustrated in FIG. 4, refers to the dimension ½ of the vertical distance between a tire circumferential direction center point of the minimal value and a tire circumferential direction center point of the maximal value. Note that the secondary waveform illustrated in FIG. 4 is the imaginary line (dashed line) joining the tire circumferential direction center points of the trough portions.

The wavelength λ1 of the primary waveform sipe and/or the amplitude λ1 of the primary waveform sipe, along with the wavelength λ2 of the secondary waveform sipe and/or the amplitude y2 of the secondary waveform sipe are configured to vary in the tire width direction. As a result, particularly, the length of the sipes can be locally increased and the density of the sipes in the tire width direction can be locally increased. As a result, balance between the edge length of the land portion and the block rigidity can be adjusted.

For example, as illustrated in FIG. 4, in cases where the wavelength λ1 of the primary waveform sipe is larger and the amplitude y1 is smaller at the vicinity of the outer sidle in the tire width direction than at the vicinity of the tire width direction center of the block land portion 4, spacing of the sipes in the vicinity of the outer side in the tire width direction is wider. As a result, the rigidity on the outer side in the tire width direction of the block land portion 4 can be increased. Additionally, as illustrated in FIG. 4, in cases where the wavelength λ2 of the secondary waveform sipe is larger and the amplitude y2 is smaller at the vicinity of the outer side in the tire width direction than at the vicinity of the tire width direction center of the block land portion 4, spacing of the sipes in the vicinity of the outer side in the tire width direction is wider. As a result, the rigidity on the outer side in the tire width direction of the block land portion 4 can be increased. With the configuration described above in which the block land portion 4 has the sipe illustrated in FIG. 4, sufficient rigidity can be ensured on the outer side in the tire width direction and, as a result, dry performance can be enhanced.

Thus, the length and the density of the sipe can be increased in at least a portion in the tire width direction by making the form of the sipe 6b complex and, furthermore, by varying the amplitude and the wavelength of the primary waveform and the secondary waveform at predetermined locations in the tire width direction. As a result, the direction of collapsing of the land portion in the vicinity of the sipe is dispersed in a predetermined range and, therefore, sufficient rigidity of the land portion in the vicinity of the sipe can be locally obtained. Additionally, due to configuring the amplitude and the wavelength of each of the waveforms as described above, the edge length of the land portion can be increased in a predetermined range and, thereby, the biting effects by the pattern edges can be sufficiently locally ensured. As a result, balance between the edge length of the land portion and the block rigidity can be appropriately adjusted.

Note that the description given above pertains to the sipe (Al but, as illustrated in FIG. 3, the sipe 6a has the same form as the sipe 6b except that the sipe 6a does not have extending portions in the tire width direction located at both ends in the tire width direction of the sipe 6b. Additionally, the sipes 6c and 6d have the same tire width direction form as the sipe 6b. Furthermore, the forms of the sipes 6e to 6h are configured so that the peaked forms and trough forms thereof are substantially inverted, with respect to the sipes 6a to 6d from the vicinity of the center in the tire width direction of the block land portion 4 up to the circumferential grooves 2 located on both sides in the tire width direction of the block land portion 4. Therefore, similar to the sipe ob described above, rigidity of the land portion in the vicinity of the sipes can be sufficiently obtained with regards to the sipes 6a and 6c to oh as well, and the edge length of the block land portion 4 can be increased.

Thus, with the pneumatic tire of the second embodiment, each of the sipes 6a to 6h is, as a whole, a primary waveform sipe having, in the tread road contact surface, at least one peak portion and one trough portion, and this primary waveform sipe is also an aggregation of secondary waveform sipes having a shorter wavelength. Additionally, with the pneumatic tire of the second embodiment, the wavelength λ1 of the primary waveform sipe and/or the amplitude y1 of the primary waveform sipe, along with the wavelength λ2 of the secondary waveform sipes and/or the amplitude y2 of the secondary waveform sipes are configured to vary in the tire width direction. As a result, the direction of collapsing of the land portion caused by the presence of the sipe can be dispersed in a predetermined range in the tire width direction and, therefore, the rigidity of the land portion can be locally increased and the edge length of the land portion can be increased in a predetermined range in the tire width direction. Therefore, biting effects by the pattern edges can be locally sufficiently ensured. As a result, balance between the edge length of the land portion and the block rigidity can be adjusted and, therefore, both performance on ice and dry performance can be achieved.

### EXAMPLES

Pneumatic tires according to the embodiments, a Conventional Example, and Comparative Examples were manufactured and evaluated. Note that the pneumatic tires manufactured according to the embodiments are Working Examples. The Comparative Examples are not the same as the Conventional Example.

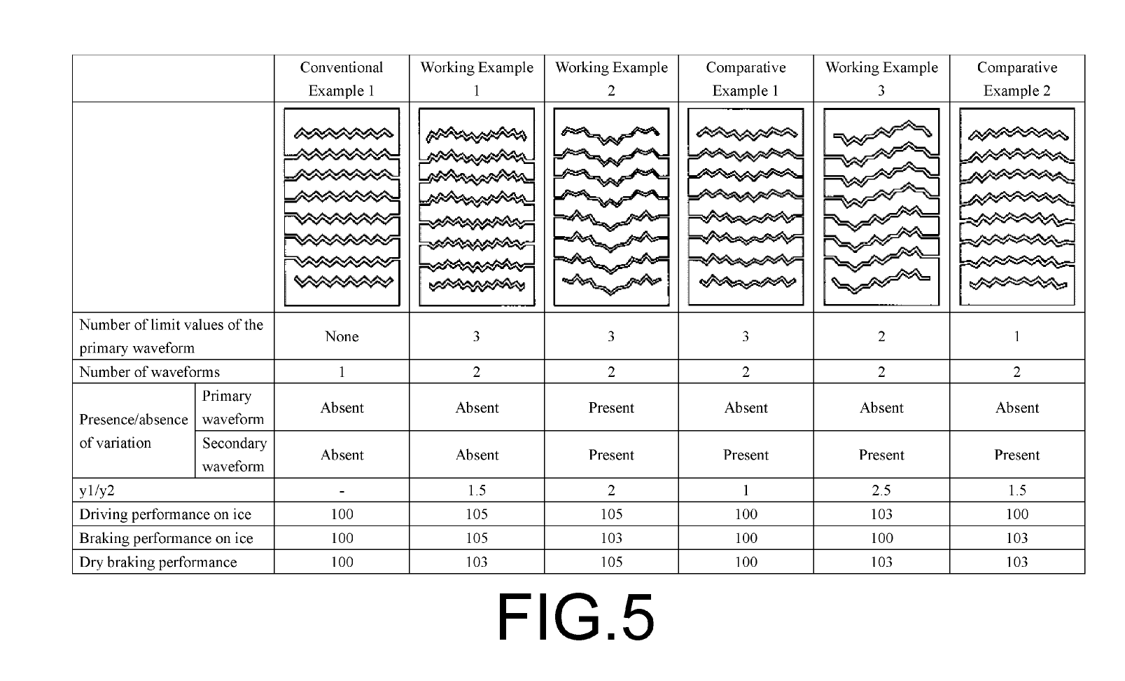

Pneumatic tires for each of Working Examples 1 to 3, Conventional Example 1, and Comparative Examples 1 and 2 were manufactured. Each of these tires had a common tire size of 195/65R15. The tires were provided with a basic block pattern throughout the entire circumference of the tire, and the sipe group illustrated in FIG. 5 was formed in each of the block land portion. Note that in each of the pneumatic tires, the number of limit values of the primary waveform, the number of waveforms, the presence/absence of variation in each of the primary waveform and the secondary waveform, and y1/y2 are as shown in NG. 5. In FIG. 5, with regards to the variation of the primary waveform and the secondary waveform, “present” refers to a case where both the wavelength and the amplitude of each waveform is configured so as to vary, and “absent” refers to a case where neither the wavelength nor the amplitude of each waveform is configured so as to vary.

The test tires were assembled on rims having a run size of 15×6JJ and were inflated to an air pressure of 230 kPa. Then, the test tires were evaluated for performance on ice (driving performance on ice and braking performance on ice) and dry performance (thy braking performance) according to the following testing methods. A 1,500 cc class general passenger car (Corolla Axio) was used as the test vehicle.

For driving performance on ice, transit time when driving a distance of 0 in to 30 in on a polished eisbahn (icy road surface) was measured. For braking performance on ice, stopping distance when braking from an initial speed of 40 km/hr on the icy road surface was measured. For My performance, stopping distance when braking from an initial speed of 100 km/hr on a dry road surface was measured.

For each of these performances, relative index values were calculated with the pneumatic tire of Conventional Example 1 being assigned a value of 100. In the case of each of the indexes, larger values indicate superior performance. Results of each of these evaluations are shown in FIG. 5.

As is clear from FIG. 5, all of the pneumatic tires of Working Examples 1 to 3 that arc within the scope of the present technology obtained superior results (exceeding 100) with regards to driving performance on ice and dry braking performance. Additionally, except for Working Example 3, superior results exceeding 100 were obtained for braking performance on ice as well. This is because in the pneumatic tires of Working Examples 1 to 3, the sipe was, as a whole, a primary waveform sipe having, in the tread road contact surface, at least one peak portion and one trough portion; the primary waveform sipe was also an aggregation of secondary waveform sipes having a shorter wavelength; and, furthermore, y1>y2 was satisfied.

Taking the pneumatic tires of Working Examples 1 to 3 individually, the wavelength and the amplitude of the primary waveform and the secondary waveform were configured so as to vary within the predetermined range in the tire width direction in the pneumatic tire of Working Example 2 and, as a result, dry braking performance was enhanced compared with the pneumatic tire of Working Example 1. Additionally, in Working Example 3, the wavelength and the amplitude of the secondary waveform were configured so as to vary within the predetermined range in the tire width direction, but the primary waveform had two limit values and, as a result, the performances were equal or inferior to those of Working Examples 1 and 2, where the primary waveform had three limit values.

In contrast, with the pneumatic tires of Comparative Examples 1 and 2, which were outside the scope of the present technology, at least one of the driving performance on ice, the braking performance on ice, and the dry braking performance was evaluated to be the same as the Conventional Example 1. A reason why superior effects of all of evaluated performances were not obtainable was because in Comparative Example 1, while the primary waveform had three limit values, y1>y2 was not satisfied and, furthermore, the wavelength and the amplitude of the primary waveform were not configured so as to vary within the predetermined range in the tire width direction. Moreover, in Comparative Example 2, superior effects for driving performance on ice, were particularly not obtainable because the primary waveform had one limit value.

What is claimed is:

1. A pneumatic tire comprising a plurality of blocks in a tread portion, a sipe being provided in at least one of the blocks, wherein in a tread road contact surface, the sipe is, as a whole, a primary waveform sipe having at least one peak portion and one trough portion, and the primary waveform sipe is also an aggregation of secondary waveform sipes having a shorter wavelength.

2. The pneumatic tire according to claim 1, wherein when a wavelength and an amplitude of the primary waveform sipe are λ1 and y1, respectively, and a wavelength and an amplitude of the secondary waveform sipe are λ2 and y2, respectively, λ1≧2×(λ2) or y1>y2 is satisfied.

3. The pneumatic tire according to claim 1, wherein at least one of the wavelength λ1 of the primary waveform sipe and the amplitude y1 of the primary waveform sipe, along with at least one of the wavelength λ2 of the secondary waveform sipe and the amplitude y2 of the secondary waveform sipe are varied in a tire width direction.

4. The pneumatic tire according to claim 2, wherein the amplitude y1 of the primary waveform sipe is not less than 1.5 mm, and the amplitude y2 of the secondary waveform sipe is not less than 0.8 mm.

5. The pneumatic tire according to claim 2, wherein the wavelength λ1 of the primary waveform sipe is not less than ⅓ of a width of the block in which the primary waveform sipe is formed, and the wavelength λ2 of the secondary waveform sipe is not less than 2.0 mm.

6. The pneumatic tire according to claim 1, wherein at least a portion of the sipe is three-dimensional.

7. The pneumatic tire according to claim 1, wherein at least one of an amplitude y1 of the primary waveform sipe and an amplitude y2 of the secondary waveform sipe varies in the tire width direction, and a relationship of a minimal value y1ₘᵢₙ of the amplitude y1 of the primary waveform sipe and a maximal value y2ₘₐₓ of the amplitude y2 of the secondary waveform sipe is configured so that y1ₘᵢₙ>y₂ₘₐₓ is satisfied.

8. The pneumatic tire according to claim 1, wherein at least one of an wavelength λ1 of the primary waveform sipe and a wavelength λ2 of the secondary waveform sipe varies in the tire width direction, and a relationship of a minimal value λ1ₘᵢₙ of the wavelength λ1 of the primary waveform sipe and a maximal value λ2ₘₐₓ of the wavelength λ2 of the secondary waveform sipe is configured so that λ1ₘᵢₙ≧2×(λ2ₘₐₓ) is satisfied.

9. The pneumatic tire according to claim 1, wherein the sipe is one of a plurality of sipes, at least one of the plurality of sipes including extending portions in the tire width direction located at both ends in the tire width direction of the at least one of the plurality of sipes.

10. The pneumatic tire according to claim 9, wherein another at least one of the plurality of sipes does not include the extending portions.

11. The pneumatic tire according to claim it wherein at least a portion of the sipe is curved in a depth direction of the at least one of the blocks.

12. The pneumatic tire according to claim 1, wherein a secondary waveform of the secondary waveform sipe is a triangular wave.

13. The pneumatic tire according to claim 1, wherein a primary waveform of the primary waveform sipe is a sine wave.

14. The pneumatic tire according to claim 1, wherein a primary waveform of the primary waveform sipe and a secondary waveform of the secondary waveform sipe comprise sine or triangular wave shapes and the primary waveform comprises a different wave shape than the secondary waveform.

15. The pneumatic tire according to claim 1, peaked forms and trough forms of the sipe are inverted up to circumferential grooves located on sides in the tire width direction of the at least one of the blocks.

16. The pneumatic tire according to claim 1, wherein the primary waveform sipe comprises at least two limit values.

17. The pneumatic tire according to claim 1, wherein the primary waveform sipe comprises at least three limit values including at least two maximal values and one minimal value, and wherein the primary waveform sipe also exists outward, on both sides in the tire width direction, of the two maximal values.

18. The pneumatic tire according to claim 1, wherein the primary waveform sipe is formed by a plurality of the secondary waveform sipes linked in a continuous mariner.

19. The pneumatic tire according to claim 1 wherein a wavelength λ1 of the primary waveform sipe is larger at a vicinity of the outer side in a tire width direction than at a vicinity of a tire width direction center of the at least one of the blocks, and an amplitude y1 of the primary waveform sipe is smaller at the vicinity of the outer side in the tire width direction than at the vicinity of the tire width direction center of the at least one of the blocks.

20. The pneumatic tire according to claim 1, wherein a wavelength λ2 of the secondary waveform sipe is larger at a vicinity of the outer side in a tire width direction than at a vicinity of a tire width direction center of the at least one of the blocks, and an amplitude y2 of the secondary waveform sipe is smaller at the vicinity of the outer side in the tire width direction than at the vicinity of the tire width direction center of the at least one of the blocks.
